(19) United States
(12) Patent Application Publication
(10) Pub. No.: US 2009/0117285 A1
(43) Pub. Date: May 7, 2009

(54) ROOM TEMPERATURE ELECTROLESS IRON BATH OPERATING WITHOUT A GALVANIC COUPLE FOR DEPOSITION OF FERROMAGNETIC AMORPHOUS FeB FILMS

(76) Inventors: Michael A. Dinderman, Bethesda, MD (US); Walter J. Dressick, Waldorf, MD (US); Ronald R. Price, Stevensville, MD (US); Paul E. Schoen, Alexandria, VA (US); Syed B. Qadri, Fairfax Station, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/188,873

(22) Filed: Aug. 8, 2008

Related U.S. Application Data
(60) Provisional application No. 60/954,653, filed on Aug. 8, 2007.

(51) Int. Cl. B05D 1/18

(52) U.S. Cl. 427/439

(57) ABSTRACT

Provided is an electroless iron bath capable of depositing a ferromagnetic FeB coating onto Pd/Sn-catalyzed substrates at room temperature without the need for an accompanying galvanic couple. The new electroless iron bath is comprised of Fe²⁺ as the metal source, citrate as the metal chelator, boric acid buffer as the pH controller, and borohydride as the reductant. Surface analysis following plating confirms the deposition of an amorphous FeB coating onto the surface of Pd/Sn-catalyzed cellulose microfibers.

### CROSS-REFERENCE TO RELATED APPLICATIONS

This Application is a Non-Prov of Prov (35 USC 119(e)) application 60/954,653 filed on Aug. 8, 2007, which is incorporated herein in its entirety.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

Electroless metallization is a method for the deposition of a metal film onto a substrate via catalyzed chemical reduction of solution-phase metal ions at the substrate surface. A typical electroless plating bath comprises an aqueous solution containing metal ions (i.e., metal source) bound by complexation with a ligand chelator, a buffer to control pH, and a reductant. Often, stabilizers, refining agents, and other minor components are added to the plating bath to improve the lifetime of the bath and the quality of the plated metal. Upon contact of the plating bath with an appropriate catalytic surface, separate redox reactions involving reduction of metal ions to metal and oxidation of the reducing agent occur to plate metal onto the substrate surface. Specific plating bath conditions (e.g., pH and metal ion, reductant, and chelator types and concentrations), as governed by mixed potential theory, are necessary to initiate and sustain electroless plating. Further conditions (e.g., bath stability and a controlled deposition rate) must be met to selectively plate a metal layer of the desired physical, electronic, or magnetic properties onto a substrate.

Many electroless plating baths have been developed to deposit commercially desirable metals (i.e., cobalt, copper, gold, nickel, platinum, and silver) onto a variety of substrates. For example, bulk-scale commercial plating baths are available for the electroless plating of copper and nickel alloys (e.g., NiP and NiB). As a result, the electroless plating method is used widely in industry for aerospace, automotive, and electronics applications. For example, Chen, et. al., J. Thin Solid Films 379, 203 (2000), reported methods for the fabrication of micro- and nanoscale patterned electroless metal films useful as plasma-resistant etch masks and electrically conductive pathways in electronic circuit manufacture.

Recently, there has been an interest in developing methods for the electroless deposition of novel magnetic materials (e.g., iron-plated particles) because of their expected utility in various electronics applications. Consequently, a variety of methods have been described for electroless deposition of iron-based ferromagnetic materials, together with the physical and magnetic properties of the resulting deposits. However, several of these methods require a sacrificial galvanic couple (e.g., an Al strip in contact with the electroless bath and metallic substrate to be plated), limiting their usefulness to macroscopic substrates. In addition, all the methods require elevated temperatures to achieve successful plating. The resulting deposits are invariably composed of an iron alloy (e.g., FeB, FeP, FeCo, FeNi, FeSnB, FeMoB, or FeNiP), and the composition of each deposit is dependent on the bath formulation and plating conditions employed. Generally, the resulting deposits are amorphous but show improved crystallinity after being annealed. Although numerous macroscale substrates (e.g., copper sheets, copper foils, carbon steel foils, and Cu/Cr-coated glass) have been plated, fewer examples exist of metallized microscale substrates, which exhibit useful dielectric and magnetic properties when incorporated into composite matrixes.

Tubular microstructures, derived from natural systems, represent a common biological motif that has been readily exploited for various applications of technological interest. Electroless plating method may be utilized to coat hollow phospholipid microtubules (see for example, Price, et. al., U.S. Pat. No. 6,936,215 issued Aug. 30, 2005; Price, et al., U.S. Pat. No. 6,013,206, issued Jan. 11, 2000; Schnur, et. al., Thin Solid Films 1987, 152, 181; Zabetakis, J. Mater. Res. 2000, 15, 2368; Zabetakis, U.S. Pat. No. 6,913,828, issued Jul. 5, 2005; and Spector, et. al., J. Adv. Mater. 1999, 11, 33725) and halloysite microtubules (see for example, Shchukin, et. al., Small 2005, 1, 510 and Baral, et. al., Chem. Mater. 1993, 5, 1227) with Ni or Cu. The resulting metallized microtubules were shown effective as containers for microencapsulation and controlled release of chemical agents, tested as field emitters for electronic display applications, and studied for use in dielectric applications. Lipid microtubules can function as effective templates for the fabrication of nanoscale Cu helical structures via the selective electroless metallization of the tubule surface seams (See Price, et. al., J. Am. Chem. Soc. 2003, 125, 11259). Although lipid microtubules possess many desirable properties (e.g., high aspect ratio, hollow center, and accessible interior and exterior surfaces easily metallized by electroless plating), they are also fragile. Lipid microtubules are readily broken into shorter fibers during standard manipulations associated with their metallization (e.g., binding Pd/Sn electroless catalysts to the surface and washing procedures). In addition, lipid tubule templates are easily destroyed by melting at the elevated temperatures utilized by many electroless baths, including known Fe baths, to enhance metal deposition. The temperature sensitivity of tubules therefore requires formulation and use of less efficient baths operating near room temperature.

### BRIEF SUMMARY OF THE INVENTION

Disclosed is a method of depositing a FeB coating onto a Pd/Sn-catalyzed substrate. A Pd/Sn-catalyzed substrate is added to an electroless iron bath, bath comprising water, source metal ion (iron(II) sulfate heptahydrate), metal chelator (sodium citrate dihydrate), pH stabilizer (boric acid buffer solution), and reducing agent (sodium borohydride). The substrate and bath are allowed to react for a period of time sufficient to deposit said FeB coating onto said substrate.

### BRIEF DESCRIPTION OF THE DRAWINGS

FIG. 1 is a the 24-factorial design matrix I;

FIG. 2 is a normal probability plot of each E(R)i (abscissa) vs. its associated Pi value (ordinate);

FIG. 3 is a plot of the residuals;

FIG. 4 is the XRD spectrum for sample 8;

FIG. 5 is a representation of neutron activation analysis data for Fe and B and the fraction of boron present as alloy;

FIG. 6 presents the EXFAS of electroless-deposited iron on cellulose fibers as well as pure Fe foil;

FIG. 7 is the Fourier transformed EXFAS functions of dotted curves simulate EXFAS;

FIG. 8 is a hysteresis loop for FeB plated cellulose nanofibers. The inset indicates the presences of a small coercive field of 35 Oe.

### DETAILED DESCRIPTION OF THE INVENTION

Disclosed is an electroless iron bath capable of depositing a ferromagnetic FeB coating onto Pd/Sn-catalyzed substrates at room temperature without the need for an accompanying galvanic couple. The new electroless iron bath is comprised of Fe²⁺ as the metal source, citrate as the metal chelator, boric acid buffer as the pH controller, and borohydride as the reductant. Surface analysis following plating confirms the deposition of an amorphous FeB coating onto the surface of Pd/Sn-catalyzed cellulose microfibers. Through the use of a two-level factorial design statistical method, (See Box, et. al., Statistics for Experimenters: An Introduction to Design, Data Analysis, and Model Building; John Wiley & Sons: New York, 1978; Chapter 10 and Bayne, et. al., Practical Experimental Designs and Optimization Methods for Chemists; VCH Publishers: Deerfield Beach, Fla., 1986; Chapter 4, both incorporated herein in their entirety) the effects of plating variables (i.e., bath pH and concentrations of each bath component) on bath behavior and identify optimal reproducible conditions for electroless Fe deposition are disclosed.

The two-level factorial statistical design methods to develop a new electroless Fe bath capable of functioning at room temperature without the need for an accompanying galvanic couple utilizes Fe(II) (0.025-0.050 M) complexed by citrate ligand (0.125-0.250 M) as a metal source in alkaline solution, with borate buffer (0.250 M total borate, pH 9.7-10.2) as a pH controller and borohydride (0.025-0.100 M) as the reductant. Statistical investigations of these variables over the ranges indicated show that only bath pH affects the quantity of metal deposited, with somewhat larger amounts of metal plated at lower pH. Plating of Pd/Sn-catalyzed cellulose microfibers is essentially complete (>98%) and is not influenced by any of the variables under these conditions, providing a wide process window for metal deposition. Surface analysis following plating confirms the deposition of an adherent amorphous ferromagnetic FeB coating of estimated thickness ˜140-346 nm and composition ˜Fe₁₀B onto the microfiber surface.

All materials were ACS reagent grade or equivalent and were used as received. Fibrous cellulose (medium length, ˜20 m diameter×˜200 m length, _{c}=0.6 g·cm⁻³), boric acid, sodium hydroxide (pellets), sodium citrate dihydrate (USP grade), and iron(II) sulfate heptahydrate were obtained from Sigma-Aldrich Corp. Cataprep™ 404 (sodium bisulfate) and Cataposit™ 44 (acidic tin chloride-palladium catalyst dispersion) were purchased from the Shipley Co. unit of Rohm and Haas (Marlborough, Mass.). Ethanol (200 proof, USP) was received from the Warner Graham Co. (Cockeysville, Md.). Milli-Q® water (18.2 M·cm⁻¹) was generated in-house and was used in the preparation of all aqueous solutions and during all fiber washing processes. Nitrogen gas was obtained as boil-off from an in-house liquid nitrogen reservoir.

Catalysis of cellulose fibers was reported Zabetakis, et al., Adv. Mater. 2005, 17, 734, incorporated herein in its entirety by reference. Briefly, Cataprep™ 404 (250 g, white solid) was first dissolved in water (2.5 L) in a glass beaker (4.0 L) with magnetic stirring at room temperature. Cellulose fibers (100 g, white solid) were added to the Cataprep™ 404 solution, which was stirred for 30 min to completely disperse the fibers. Cataposit™ 44 (50 mL, brown liquid) was then added, and the dispersion was stirred for an additional 60 min. The resulting Pd/Sn-catalyzed cellulose fibers (brown solid) were recovered by vacuum filtration, washed in water (2.0 L), and dried in a convection oven (6 h in air at 105 C). The catalyzed fibers were stored in plastic bags under a nitrogen atmosphere at room temperature. Catalyzed fibers prepared and stored in this manner maintained their activity for electroless metal deposition for at least 12 months.

Each plating bath was comprised of Milli-Q® water, source metal ion (iron(II) sulfate heptahydrate), metal chelator (sodium citrate dihydrate), pH stabilizer (boric acid buffer solution), and reducing agent (sodium borohydride). Compositions of each plating bath were governed by the two-level factorial designs used to study and map the effects of plating variables on the bath performance, as described below. Separate stock solutions containing appropriate metal/chelator ratios and pH buffers required for each two-level factorial design were prepared within 24 h of use and combined as described below to improve consistency and facilitate bath preparations. To prepare the metal/chelator stock solutions, appropriate weighed quantities of ferrous sulfate heptahydrate and sodium citrate dehydrate were placed in a 2.5 L beaker and dissolved in ˜1.8 L of water with stirring. The solution and aqueous washings were transferred into a 2.50 L volumetric flask and diluted to the mark with water. The stock pH buffers, containing a constant 0.500 M total borate concentration, were prepared by dissolving 77.29 g (1.250 mol) of boric acid and a quantity of NaOH pellets calculated to give the desired final pH in ˜2.2 L of water with stirring in a 2.5 L beaker. When the solids were dissolved and the solution had cooled to room temperature, the pH was measured using a pH meter. If necessary, the solution was titrated with additional ˜1.2 M NaOH(aq) solution to adjust the final pH. The solution and aqueous washings were then transferred to a 2.50 L volumetric flask and diluted to the mark with water. The various required metal/chelator and pH buffer stock solutions were transferred to separate polypropylene containers that were tightly sealed for storage until the solutions were needed for plating.

Each plating bath was prepared by addition of the appropriate stock buffer solution (250 mL) to the proper stock metal/chelator solution (250 mL) contained in a plastic beaker (1 L) at room temperature (22±2° C.) to achieve a plating bath with the variable values designated by the factorial design. The pH of the resulting solution was measured, the beaker was placed in a fume hood, and the appropriate quantity of solid sodium borohydride was added within 10 min and dissolved with vigorous manual stirring to complete the preparation of the electroless Fe bath.

A 250 mg sample of Pd/Sn-catalyzed cellulose fibers was quickly added in one portion with manual stirring to the Fe electroless bath (as soon as the sodium borohydride had dissolved) to initiate Fe deposition. The bath was manually stirred for 30 s, every 10 min, for the required time duration of the experiment. For experiments requiring 24 h plating times, samples were stirred for the first 4 h and then left unstirred. After the required amount of plating time had passed, a magnet placed under the beaker was utilized to separate the fibers from the liquid phase. The plated fibers were washed with water (3×100 mL) and separated using the magnet again until the washings were colorless. They were then washed with ethanol (1×100 mL), separated using the magnet, redispersed in fresh ethanol (˜100 mL), carefully decanted into a 250 mL filter funnel containing a preweighed piece of filter paper (Fisherbrand Q5 quantitative ashless) prewetted with ethanol, and recovered by vacuum filtration. The plated fibers were carefully washed on the filter successively with ethanol (2×100 mL) and acetone (2×100 mL) and air suction dried for ˜30 s following the last acetone wash. The filter paper containing the plated fibers was removed from the funnel and transferred to a preweighed plastic jar, which was placed in a heated vacuum oven (N₂ atmosphere, 40° C.) overnight to complete drying. The jars containing the plated fibers and filter papers were then stored under a nitrogen atmosphere at room temperature until the plated fibers and filter papers were needed for analysis.

From each experiment, the mass of the plated fibers, if any, was recorded and used to determine the amount of Fe deposited after subtraction of the initial mass of cellulose used (i.e., 0.250 g). A minimum of 200 fibers from each sample was then observed under a Leitz-Wetzlar optical microscope (20× magnification) and photographed to determine the average quality (i.e., percentage of the fibers plated and morphology of the metal deposit) of the plated surface. Plating of the surface of an individual fiber, when it occurred, was essentially complete (99±2%). Therefore, fibers appeared either translucent brown (catalyzed, unplated) or solid black (plated), and the plating percentage was determined by calculating the fraction of fibers that appeared black. Dried, plated fibers were determined to be ferromagnetic on the basis of whether they were attracted to a bulk magnet.

Additionally, sample 8 from the optimized design matrix II was randomly selected and characterized further to determine the composition and morphology of the metal deposit. For this sample, elemental analyses via instrumental neutron activation analysis (Fe, Sn, and Pd) and prompt neutron activation analysis (Boron) were provided by Elemental Analysis, Inc. (Lexington, Ky.). A Rigaku ATX advanced thin film X-ray diffractometer system (Cu K radiation from an 18 kW rotating anode source) was used to acquire the X-ray diffraction (XRD) data; the plated microfiber samples were mounted on a single Si(001) crystal to minimize background scattering. XPS spectra were acquired using a Thermo VG Scientific Escalab 220i-XL with a monochromatic Al K source, a hemispherical electron analyzer, and a magnetic electron lens. The sample was prepared immediately before use by depositing ˜25 mg of plated fibers onto a conducting carbon adhesive tab (Electron Microscopy Sciences, no. 77825-12) affixed to a 2 cm×2 cm Cu foil that had previously been cleaned by successive 5 min sonications in ethanol and acetone. Measurements were performed with a base pressure of 1×10⁻⁹ Torr at room temperature. Survey scans were acquired in the 0-1400 eV binding energy range (100 eV pass energy). High-resolution normal-emission angle-integrated scans of the C(1s) and B(1s) regions were acquired with 15-20 eV windows (20 eV pass energy). The XPS signals were calibrated to the C(1s) peak at 284.6 eV. The high-resolution spectra were fit using Universal Spectrum Processing and Analysis Program for ESCA-Spectra (version 2005) software.

Two-level 2ⁿ-factorial design methods, where n is the number of variables studied, were used to quantitatively estimate the effects of each variable and interaction of variables on the experimental responses. Briefly, the variables studied included various combinations of the pH, [Fe(II)], [citrate], and [BH₄⁻] as described in the text below for each design. Each variable to be studied was assigned a low and high value, coded as −1 and +1, respectively, in each design. Levels of the citrate and borohydride variables were defined as mole ratios relative to the [Fe(II)] variable, as specifically identified later in the text. Consequently, each design comprised a 2ⁿ row×n column matrix, in which each column is associated with a specific variable and each row defines a specific experiment, containing entries of −1 or +1 signifying the coded level of each variable in that experiment. Each design matrix was set up in standard order, such that the nth column consisted of 2ⁿ⁻¹ entries of −1 followed by 2ⁿ⁻¹ entries of +1, in alternating fashion to facilitate data analysis.

Each experiment was performed by randomly selecting a row of the design matrix and reading the code (i.e., −1 or +1) associated with each column entry corresponding to a particular variable for that row. An electroless bath was then prepared containing the appropriate level of each variable designated by the codes and used to plate the catalyzed cellulose fibers. The mass of Fe plated (R₁) and the percentage of fibers plated (R₂) were measured as separate experimental responses and associated with that row of the matrix. The process was repeated for another randomly chosen row (i.e., experiment) until all 2ⁿ design experiments were completed to generate response columns for the design matrix. Experiments associated with the final bath optimization described in matrix II were repeated twice to ensure reproducibility of the results.

Yates' algorithm was used to compute the effects, E(R)ᵢ (i=1, 2, . . . , 2ⁿ), of each variable or interaction of variables on a given response, R. E(R)ᵢ calculations were checked using the sum of squares method. The calculated E(R)ᵢ were identified with the variable or combination of variables having the +1 designation(s) in the ith row of the design matrix, then arranged in increasing order from most negative to most positive, and serially assigned a cumulative probability, Pᵢ, using equation (1):

Pᵢ=100·(i−½)/(2ⁿ−1) (i=1, 2, . . . , 2ⁿ−1) (eq. 1)

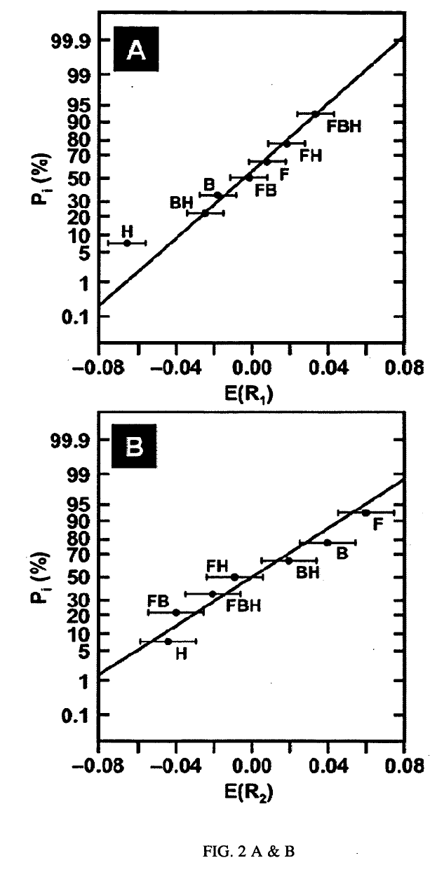

A normal probability plot of each E(R)ᵢ (abscissa) vs. its associated Pᵢ value (ordinate) gave a straight line symmetrical about the abscissa zero containing points corresponding to variables and interactions of variables having no significant influence on the response. Points associated with variables or interactions of variables exhibiting a real influence on the experimental response were identified by deviations from this straight line at the positive and/or negative extrema. A specific example is shown in FIG. 2A. For normal probability plots in which significant effects were identified, residuals (R)ᵢ were calculated using a reverse Yates algorithm as a further diagnostic check. The residuals were ordered from most negative to most positive, and each was assigned a cumulative probability, Pᵢ, according to equation 2:

Pᵢ=100·(i−½)/(2ⁿ) (wherein i=1, 2, . . . , 2ⁿ)

Plots of (R)ᵢ (abscissa) vs. Pᵢ (ordinate) on normal probability paper yielded straight lines containing all points in all cases, consistent with the correct identification of the significant effects in the normal probability plot for the corresponding effects.

2ⁿ-factorial design methods, where “n” is the number of variables studied, were used to quantitatively estimate the effects of each variable and interaction of variables on the experimental responses, except where noted. The final set of experiments associated with optimization of the bath parameters in the 2³-factorial design matrix II was repeated twice to ensure reproducibility of the results. The specific variables studied varied with each design, but included various combinations of the pH, [Fe(II)], [citrate], and [BH₄⁻]. Each variable to be studied was assigned a low and high value, coded as −1 and +1, respectively, in the design. For our experiments, the levels of the citrate and borohydride variables were defined as mole ratios relative to the [Fe(II)] variable, as specifically identified later in the text. Therefore, each design comprised a “2ⁿ” row×“n” column matrix, in which each column is associated with a specific variable and each row defines a specific experiment, containing entries of −1 or +1 signifying the coded level of each variable in that experiment. Each design matrix was set up in standard order, such that the “n^{th}” column consisted of 2ⁿ⁻¹ entries of −1 followed by 2ⁿ⁻¹ entries of +1, in alternating fashion to facilitate data analysis. However, experiments were performed in random order to minimize the effects of systematic errors, if any, on the results.

Specifically, an experiment was performed by randomly selecting a row of the design matrix and reading the code (i.e., −1 or +1) associated with each column entry corresponding to a particular variable for that row. An electroless bath was then prepared containing the appropriate low or high level of each variable designated by the codes and used to plate the catalyzed cellulose fibers. The experimental response obtained was then associated with that row of the matrix. The process was repeated for another randomly chosen row (i.e., experiment) until all 2ₙ design experiments were completed to generate a response column for the design matrix. Measurements were made for the mass of the plated Fe and the percentage of Fe-plated fibers as the experimental responses for the systems and analyzed each separately.

Because the design matrix was arranged in standard order, Yates' algorithm was used to compute the effects of each variable or interaction of variables on a given response. Specifically, the responses for each experiment (defined by each row in the standard order design matrix) in the response column were considered as successive pairs to generate a new “2ₙ” row×“n” column analysis matrix according to the formulae:

X_{i,k+1}=X_{2i,k}+X_{2i-1,k} (i=1 to 2ⁿ⁻¹; k=0 to 2ⁿ⁻²) (eq. S-1)

X_{i+j, k+1}=X_{2i,k}−X_{2i-1, k} (i=1 to 2ⁿ⁻¹; j=2ⁿ⁻¹; k=0 to 2ⁿ⁻²) (eq. S-2)

In eq. (S-1) and eq. (S-2), the X_{2i, k} and X_{2i-1, k} with k=0 (i.e., X_{2i, 0} and X_{2i-1, 0}) represent the various experimental responses from the response column associated with the experiments described by the (2i)^{th} and (2i−1)^{th} rows of the original design matrix. Therefore, X_{i, k+1} and X_{i+j, k+1} with k=0 define the row entries (i.e., X_{i, 1} and X_{i+j, 1}) for the first column of the new “2ₙ” row×“n” column analysis matrix. As indicated by eq. (S-1) and eq. (S-2), the X_{i, 2} and X_{i+j, 2} values comprising the row entries for the second column of the analysis matrix were obtained using the X_{i, 1} and X_{i+j, 1} values from the first column. Yates' algorithm was used to generate subsequent columns using the row entries of the preceding column in this manner until the “n” columns of the new “2ⁿ” row×“n” column analysis matrix were generated. The accuracy of the calculations was checked by comparing the sum of the squares for the experimental responses (i.e., R₂) with the corresponding sum of squares of the entries in each column (i.e., Cₖ²) of the analysis matrix, which are related to R² by eq. (S-3), where “k” is the column number of the analysis matrix (i.e., k=1, 2, . . . , or n) and the summation of the squared entries in each row of a particular column ranges from i=1 to i=2ₙ.

R²=Σᵢ(Rᵢ)²=2^{-k}·Σi(C_{i, k})²=2^{-k}·Cₖ² (S-3)

Each entry in the “n^{th}” column of the analysis matrix contained weighted information concerning the magnitude of the effect of each variable and combination of variables on the particular response analyzed. Division of the entry in row 1 in column “n” of the analysis matrix by 2ⁿ provided an estimate of the grand average of all observations. Estimates of the effects for a given experimental response, E(R)ᵢ, were calculated by dividing each of the remaining entries in column “n” of the analysis matrix by a 2ⁿ⁻¹ weighting factor. The calculated effects were then associated with the variable or combination of variables having the +1 designation(s) in the corresponding row of the original design matrix. Calculation details for specific examples of the application of Yates' algorithm for the analysis of the effects on the responses are shown in Tables S1 and S3 below.

The influence of each estimated effect, if any, on the experimental response was determined by plotting the effects on normal probability paper. The effects for each response were arranged in increasing order from the most negative to the most positive effect. The expected cumulative probability distribution, Pᵢ, was calculated for and serially assigned to each effect using eq. (S-4) (i.e., eq. (1) in the text), where “i”=1 corresponds to the most negative effect and “i”=2ₙ−1 corresponds to the most positive effect.

Pᵢ=100·(i−½)/(2ₙ−1) (i=1, 2, . . . , 2ₙ−1) (S-4)

A plot of the magnitude of each E(R)ᵢ (abscissa) vs. its associated Pᵢ value (ordinate) gave a straight line symmetrical about the abscissa zero containing points corresponding to variables and interactions of variables having no significant influence on the response. Points associated with variables or interactions of variables exhibiting a real influence on the experimental response were identified by deviations from this straight line at the positive and/or negative extrema. A specific example is shown in FIG. 2A.

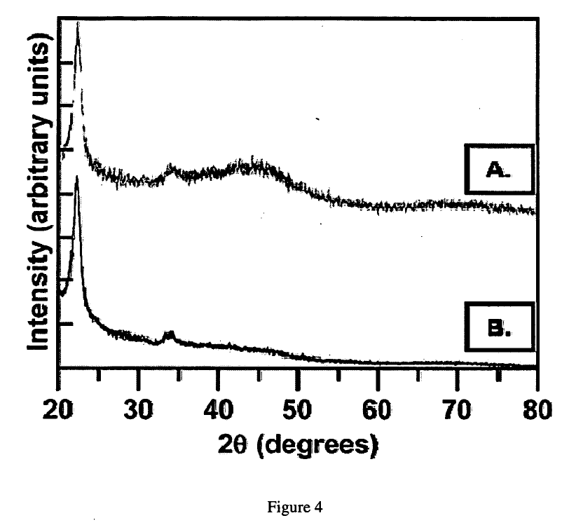

A diagnostic check using the Fe mass response residuals, Δ(R₁)ᵢ, was performed to test the validity of the information obtained from the (E(R₁)ᵢ, Pᵢ) normal probability plot (FIG. 4A). Residuals were first calculated by placing the entries from the “nₜₕ” column of Yates' E(R₁) analysis matrix (Table 1) in reverse standard order as a new matrix column. All entries in this new column associated with effects having no significant influence on the response in the normal probability plot were then set to zero. These modified entries were then analyzed via the Yates' algorithm according eq. (S-1) and eq. (S-2), as described above. The entries in the “nₜₕ” column of the new 2ₙ×n residuals matrix generated by this “reverse” Yates' algorithm were each divided by 2ₙ to yield expected values, V(R₁)ᵢ, of the responses. The residuals, Δ(R₁)ᵢ, were then calculated by subtraction of each expected response, V(R₁)ᵢ, from the observed response, (R₁)ᵢ, associated with the same variable or combination of variables in the original design and analysis matrices. Details of the calculation of the residuals are shown in Supporting Information Table S2. The residuals were placed in increasing order from the most negative to the most positive and associated with an expected cumulative probability distribution, Pᵢ, calculated from eq. (S-5) (i.e., eq. 2) in the text).

Pᵢ=100·(i−½)/(2ₙ) (i=1, 2, . . . , 2ₙ) (S-5)

A plot of the magnitude of each residual (abscissa) vs. its associated Pᵢ value (ordinate) gave a straight line containing all the points, symmetrical about the abscissa zero, whenever all variables significantly influencing the response have been correctly identified in the normal probability plot. Tables S1-S3 and Figure S1 follow:

TABLE S1
Forward Yates' algorithm analysis matrix for calculation of estimated
effects for weight of plated Fe data.

| | | | | | | | Identity^{b} | E(R₁)ᵢ^{d} | |
|---|---|---|---|---|---|---|---|---|---|
| Sample | | | | | Divisor^{b} | | Factor | Std. | |
| (#) | (R₁)ᵢ^{a} | C₁^{b} | C₂^{b} | C₃^{b} | (D)ᵢ | E(R₁)ᵢ^{b,c} | (Codes) | order | Pᵢ^{e} |
| 1 | 0.201 | 0.426 | 0.867 | 1.472 | 8 | 0.184 | Average | — | — |
| 2 | 0.225 | 0.441 | 0.605 | 0.032 | 4 | 0.008 | F | −0.0655 | 7.14 |
| 3 | 0.243 | 0.346 | −0.021 | −0.072 | 4 | −0.018 | B | −0.0255 | 21.43 |
| 4 | 0.198 | 0.259 | 0.053 | −0.004 | 4 | −0.001 | FB | −0.018 | 35.71 |
| 5 | 0.176 | 0.024 | 0.015 | −0.262 | 4 | −0.0655 | H | −0.001 | 50.00 |
| 6 | 0.170 | −0.045 | −0.087 | 0.074 | 4 | 0.0185 | FH | 0.008 | 64.29 |
| 7 | 0.100 | −0.006 | −0.069 | −0.102 | 4 | −0.0255 | BH | 0.0185 | 78.57 |
| 8 | 0.159 | 0.059 | 0.065 | 0.134 | 4 | 0.0335 | FBH | 0.0335 | 92.86 |

Measured value; mass of plated Fe after initial mass (0.250 g; catalyzed cellulose fibers) was subtracted from final mass (Fe-plated, cellulose fibers) for each sample.
^{a}Yates' algorithm data showing calculated analysis matrix columns C1, C2, and C3.
^{b}Estimates of factor effects and interactions, calculated from forward Yates' algorithm.
^{c}Standard order ranks effects from lowest to highest, excluding average value.
^{d}Pi = 100 · (i − 0.5)/(2n − 1); where n = 3 and i = 1, 2, 3, . . . , 2n − 1.

TABLE S2
Reverse Yates' algorithm analysis matrix for calculation of residuals from estimated effects.

| Identifier | | | | | | | | | Δ(R₁)ᵢ | |
|---|---|---|---|---|---|---|---|---|---|---|
| Factor | | | | | Divisor | | | | std. | |
| (Codes) | C₃^{a} | RC₁ | RC₂ | RC₃ | (Dᵢ) | V(R₁)ᵢ^{b} | (R₁)ᵢ^{c} | Δ(R₁)ᵢ^{d} | order | Pᵢ^{e} |
| FBH | 0 | 0.000 | −0.262 | 1.210 | 8 | 0.151 | 0.159 | 0.008 | −0.051 | 6.25 |
| BH | 0 | −0.262 | 1.472 | 1.210 | 8 | 0.151 | 0.100 | −0.051 | −0.019 | 18.75 |
| FH | 0 | 0.000 | −0.262 | 1.210 | 8 | 0.151 | 0.170 | 0.019 | −0.016 | 31.25 |
| H | −0.262 | 1.472 | 1.472 | 1.210 | 8 | 0.151 | 0.176 | 0.025 | 0.008 | 43.75 |
| FB | 0 | 0.000 | −0.262 | 1.734 | 8 | 0.217 | 0.198 | −0.019 | 0.008 | 56.25 |
| B | 0 | −0.262 | 1.472 | 1.734 | 8 | 0.217 | 0.243 | 0.026 | 0.019 | 68.75 |
| F | 0 | 0.000 | −0.262 | 1.734 | 8 | 0.217 | 0.225 | 0.008 | 0.025 | 81.25 |
| Average | 1.472 | 1.472 | 1.472 | 1.734 | 8 | 0.217 | 0.201 | −0.016 | 0.026 | 93.75 |

^{a}Reverse of C3(Table S1), modified to replace values expected to be due to noise with a “zero”.
^{b}Estimates of factor effects and interactions, calculated from reverse Yates' algorithm.
^{c}Measured value from Table S1.
^{d}Δ(R1)i = (R1)i − V(R1)i = residual values for estimates of factor effects and interactions.
^{e}Pi = 100 · (i − 0.5)/(2n); where n = 3 and i = 1, 2, 3, . . . 7, or 2n).

TABLE S3
Yates' algorithm analysis matrix for calculation
of E(R2) from percentages of plated fibers:

| | | | | | | | | E(R₂)ᵢ^{d} | |
|---|---|---|---|---|---|---|---|---|---|
| Sample | | | | | Divisor^{b} | | | std. | |
| (#) | R₂^{a} | C₁^{b} | C₂^{b} | C₃^{b} | (Dᵢ) | E(R₂)ᵢ^{b,c} | Identity^{b} | order | Pᵢ^{e} |
| 1 | 99.11 | 199.11 | 398.62 | 795.5 | 8 | 99.437 | Average | — | — |
| 2 | 100.00 | 199.51 | 396.88 | 2.36 | 4 | 0.589 | F | −0.435 | 7.14 |
| 3 | 99.51 | 197.85 | 1.38 | 1.59 | 4 | 0.398 | B | −0.411 | 21.43 |
| 4 | 100.00 | 199.03 | 0.98 | −1.64 | 4 | −0.411 | FB | −0.208 | 35.71 |
| 5 | 98.37 | 0.89 | 0.41 | −1.74 | 4 | −0.435 | H | −0.101 | 50.00 |
| 6 | 99.48 | 0.49 | 1.19 | −0.41 | 4 | −0.101 | FH | 0.195 | 64.29 |
| 7 | 99.58 | 1.11 | −0.41 | 0.78 | 4 | 0.195 | BH | 0.398 | 78.57 |
| 8 | 99.45 | −0.13 | −1.24 | −0.83 | 4 | −0.208 | FBH | 0.589 | 92.86 |

^{a}The percentage of recovered fibers that appeared black (i.e., Fe-plated) when viewed under an optical microscope at 20× magnification from Table 1.
^{b}Yates' algorithm data.
^{c}Estimates of factor effects and interactions, calculated from forward Yates' algorithm.
^{d}Standard order ranks effects from lowest to highest, excluding average value.
^{e}Pi = 100 · (i − 0.5)/(2n − 1); where n = 3 and i = 1, 2, 3, . . . , 2n − 1.

Because of its less favorable redox and catalytic activities compared to more noble metals, Fe is often electrolessly co-deposited in the form of alloys with other more active metals, such as Ni or Co. Electroless baths for the deposition of binary alloys containing only Fe, together with smaller amounts of nonmetals such as B or P, are less common, but provide a convenient starting point for the development of new Fe electroless baths due to their comparative simplicity and low cost. Such baths typically contain a ferrous salt complexed by a carboxylate-based chelator ligand such as citrate, tartrate, or glycine as the metal source, in combination with a strong reducing agent such as borohydride or hypophosphite in alkaline solution. Solution pH in these baths is typically adjusted by direct addition of base and often moderated only by the buffer capacity of any free ligand present. Therefore, we opted to initiate our investigation using baths prepared from ferrous sulfate, sodium citrate, and sodium borohydride in an alkaline borate buffer (pKₐ₁=9.23) solution to minimize potential pH variations during plating due to metal ion-buffer interactions and changes in free ligand concentrations.

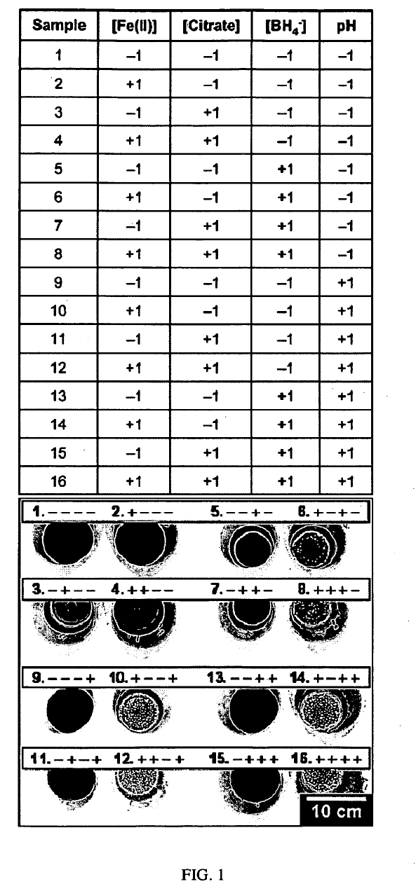

To most efficiently identify and assess the effects due to changes in levels of bath component variables on the amount and quality of plated material and optimize our process, we employed two-level factorial statistical design methods to plan, execute, and analyze our experiments. As our starting point, we used the 2⁴-factorial design matrix I shown in FIG. 1 (top) to screen the effects of the [Fe(II)], [citrate], [BH₄⁻], and pH variables on the completeness and quantity of plating and refine the range of each variable, on the basis of the observed plating trends, for subsequent studies. For each variable, minimum and maximum values, coded respectively by entries of −1 and +1 in FIG. 1 (top), were chosen to cover what we believed to be the widest range capable of providing a stable plating bath and producing magnetic fibers. For bath alkalinity, we selected a range of 1 pH unit with minimum and maximum levels of pH 9.2 (−1) and pH 10.2 (+1), respectively, controlled by the borate buffer. Initial levels for [Fe(II)] were 0.005 M (−1) and 0.050 M (+1). The [citrate] and [BH₄⁻] ranges were defined on the basis of the [Fe(II)] values. The lower [citrate] level (−1) was set at 3[Fe(II)], an amount just sufficient for complete formation of a tris-bidentate citrate complex of Fe(II) in solution, with the high level at 5[Fe(II)] providing baths containing excess citrate ligand. Because noticeable hydrogen gas evolution consistent with [BH₄⁻] decomposition occurred during use of the baths, [BH₄⁻] levels of [Fe(II)] (−1) and 5[Fe(II)] (+1) were chosen to ensure that sufficient reductant remained available for reduction of Fe(II) during the course of each experiment. Other parameters, including the bath volume (500 mL), quantity of catalyzed cellulose (250 mg), and temperature (22±2 C) remained constant during the fixed 24 h plating time.

FIG. 1a shows the 2⁴-factorial design matrix showing the Fe(II), citrate, and borohydride concentration and pH variables with low and high coded levels designated as −1 and +1 table entries, respectively. Specific concentrations corresponding to the −1 and +1 designations for each variable are described elsewhere. Other plating conditions are defined by the matrix (top) and described in the elsewhere. The identifier above each beaker serially lists the experiment number and the coded levels of Fe(II), citrate, and borohydride concentrations and pH, respectively, from the matrix (top). Note that + and − were used, rather than +1 and −1, respectively, for the beaker variable codes due to space limitations.

The photograph in FIG. 1b (bottom) shows the baths containing the treated microfibers immediately after completion of the 24 h plating for each of the 16 experiments of the 2⁴-factorial design matrix I. All plating baths were a clear, yellow-green color when first prepared, just prior to addition of the catalyzed cellulose fibers. Hydrogen gas evolution initiated upon addition of the fibers and metallization, when it occurred, was evident within ˜5 min by blackening of the fibers. Plating was accompanied by bleaching of the bath color, yielding a frothy gray mixture. As plating rates and frothing decreased with time, new solution colors developed as shown in FIG. 1 (bottom). In all cases, bath alkalinity increased only slightly (i.e., ˜0.1-0.2 pH unit) after plating, consistent with good control of the solution pH by the borate buffer.

The deposition of gray-black, adherent, metal coatings onto the fibers in some experiments was accompanied or supplanted by other competitive processes in the baths, complicating interpretation of the results. For example, rapid color bleaching, plating, and gas evolution rates were observed for baths 6, 8, and (especially) 14 and 16, resulting in less adherent metal deposits which were partially separated from the fibers by means of the foaming action of the bath and/or mechanical manipulations during filtration. In contrast, baths 9, 11, 13, and 15 developed an orange-yellow color and cloudy appearance, indicative of the formation of colloidal iron hydroxide/oxide (i.e., rust), within ˜90 min after initiation of plating. Recovered fibers from baths 9 and 11 were orange-brown in color and nonmagnetic, consistent with the deposition of rust, rather than metal, onto the fibers. Gray-black, magnetic metal fibers were successfully isolated from baths 13 and 15, though the fibers from bath 15 were visibly contaminated with particles of the orange-brown rust precipitate. Although solution color changes in baths 1-4 generally differed from those of baths 9, 11, 13, and 15, these baths also yielded brown, nonmagnetic fibers that were difficult to recover during filtration.

Although these problems preclude a quantitative statistical analysis of the effects of the variables on the completeness and amount of plating, design matrix I nevertheless yields sufficient qualitative information to narrow the range of variables to improve the plating behavior. For example, examination of matrix I indicates that the formation of nonmagnetic fibers corresponds to low [BH₄⁻] levels, generally in combination with low pH and/or low [Fe(II)] levels, in baths 1-4, 9, and 11. Likewise, formation and precipitation of rust in baths 9, 11, 13, and 15 is qualitatively correlated with low [Fe(II)] and high pH levels in these baths. In addition, the design results suggest that poor adhesion of the metal deposit to the fibers is likely associated with high [Fe(II)] and [BH₄⁻] levels in baths 6, 8, 14, and 16.

Using these qualitative observations, a second design matrix was set up in which the ranges of the variables were adjusted to address these problems. For this second matrix, the high levels (+1) for [Fe(II)] (i.e., 0.05 M) and pH (i.e., 10.2) remained unchanged, but the low levels (−1) were raised to [Fe(II)]=0.025 M and pH 9.7 to minimize the formation of nonplated fibers. Because visual observations from the matrix I experiments suggested that metal deposition was essentially complete (i.e., >˜95%) after 4-5 hr plating time was also reduced from 24 to 4 h to limit the possibility for competitive precipitation of iron hydroxide/oxide. In addition, to lower the activity of the baths and improve the adhesion of the plated metal, the high level (+1) for [BH₄⁻] was reduced to 2[Fe(II)], keeping the low level (−1) unchanged at [Fe(II)]. Finally, because [citrate] was not identified as an important factor affecting plating in our qualitative analysis of matrix I, it was fixed at a constant level of 5[Fe(II)] for all experiments in matrix II. Consequently, matrix II comprised a 2³-factorial design shown in Table 1 in which the three variables examined were [Fe(II)], [BH₄⁻], and pH.

Table 1

TABLE 1
Bath Optimization, a 2³-Factorial Design Matrix, Arranged in Standard (Yates') Order

| | | | | | | | | Fe % |
|---|---|---|---|---|---|---|---|---|
| | | | | Fe mass (g) | Fe mass | Fe mass (g) | Fe % plating | plating |
| sample | [Fe(II)],^{ab} | [BH₄⁻],^{ab} | pH,^{b} | measured, | (g) effect, | residual, Δ | measured, | effect, |
| no. | F^{c} | B^{c} | H^{c} | (R₁)ᵢ^{d} | E(R₁)ᵢ^{e} | (R₁)ᵢ^{f} | (R₂)ᵢ^{g} | E(R₂)ᵢ^{h} |
| 1 | −1 | −1 | −1 | 0.201 | 0.184 | 0.008 | 99.11 | 99.437 |
| 2 | +1 | −1 | −1 | 0.225 | 0.008 | −0.051 | 100.00 | 0.589 |
| 3 | −1 | +1 | −1 | 0.243 | −0.018 | 0.019 | 99.51 | 0.398 |
| 4 | +1 | +1 | −1 | 0.198 | −0.001 | 0.025 | 100.00 | −0.411 |
| 5 | −1 | −1 | +1 | 0.176 | −0.0655 | −0.019 | 98.37 | −0.435 |
| 6 | +1 | −1 | +1 | 0.170 | 0.0185 | 0.026 | 99.48 | −0.101 |
| 7 | −1 | +1 | +1 | 0.100 | −0.0255 | 0.008 | 99.58 | 0.195 |
| 8 | +1 | +1 | +1 | 0.159 | 0.0335 | −0.016 | 99.45 | −0.208 |

^{a}Concentration (mol · L⁻¹) of the component in the plating bath.
^{b}The +1 and −1 symbols signify the high and low levels of each variable, respectively, used for each experiment, as described and defined in the text.
^{c}Identifier label for each variable, as used in statistical analyses and FIG. 4.
^{d}Mass of plated Fe, in units of grams, after the initial mass (0.250 g, catalyzed cellulose fibers) was subtracted from the final mass (Fe-plated, cellulose fibers) for each sample. Uncertainty ±15%.
^{e}Estimates of factor effects and interactions, calculated from the forward Yates algorithm matrix for mass of plated Fe data (see Table S1).
^{f}Residual values, calculated from the reverse Yates algorithm analysis matrix for mass of plated Fe data (see Table S2).
^{g}Percentage of recovered fibers that appeared black (i.e., Fe−plated) when viewed under an optical microscope at 20× magnification. Uncertainty ±1%.
^{h}Estimated effects, calculated from the forward Yates algorithm matrix for percentage of Fe-plated fibers data (see Table S3).

In contrast to matrix I, the problems associated with iron hydroxide/oxide precipitation, plating failure, and metal adhesion were completely eliminated by the changes in variable levels in matrix II. For all experiments, bath solutions remained pale yellow in color at the conclusion of the plating process and adherent, gray-black magnetic fibers were isolated. The samples were predominantly comprised of completely plated, gray-black fibers (>˜98%). The samples were relatively free of debris (e.g., plated, nonfiber material), consistent with initiation and subsequent growth of metal on the catalyzed fiber surface as the primary metal deposition mechanism in our systems. Although surface features consistent with limited nonhomogeneous plating (e.g., nodules, pits) were occasionally observed, the level of such defective fibers never exceeded 5% of the fibers examined for a given experiment.

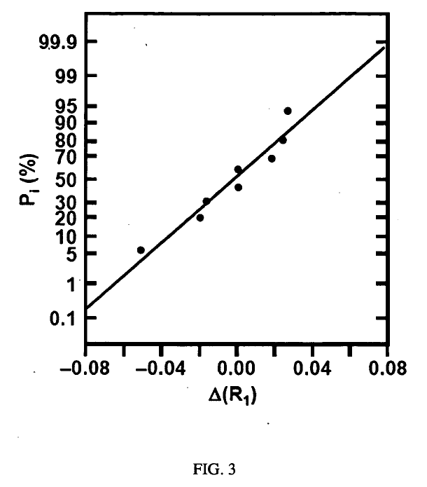

Attempts to use SEM or TEM to directly assess plating thickness and homogeneity via cross-sectional measurements of microtome samples containing epoxy-embedded plated fibers were confounded by image distortions due to the fibers' magnetic fields. However, the relative uniformity of the coating observed in the optical micrograph of FIG. 3B permitted an estimate of plating thickness from the mass of plated Fe and the cylindrical fiber geometry. Specifically, for an experiment in which the mass of the cellulose fibers was exactly doubled as a result of Fe deposition, the average thickness of an Fe plate, y, uniformly covering a single cylindrical cellulose fiber could be estimated as y 3.56×10⁻⁵ cm (i.e., 356 nm) from the positive root of equation (3):

2πy³+π(4r+h)y²+2πr(r+h)y−πr²hρ_{c}/ρ_{Fe}=0

The terms r and h in eq 3 are the radius and length (cm), respectively, of a cellulose fiber, ρ_{c} (=0.6 g·cm⁻³) is the density of the cellulose fibers, and ρ_{Fe} (=7.86 g cm⁻³) is the density of Fe. For fibers less well plated, the Fe thickness calculated using the mass data (R₁) from matrix II in Table 1 scales according to eq 4.

y=(weight Fe (g)/0.0250 g)·356 nm (4)

Using the data from Table 1, thickness estimates range from 140 nm for the least plated sample from experiment 7 to ˜346 nm for the most plated sample from experiment 3.

In addition to the measured masses of plated metal (R₁), Table 1 also summarizes the percentages of metal plated fibers (R₂) obtained as responses for each experiment. The effects (i.e., E(R₁) and E(R₂)) for each response and residuals for the plated metal mass response (i.e., (R₁)), calculated using Yates' algorithm methods, are also separately tabulated. Details of these calculations are presented in Tables S1-S3. In addition, the variable or combination of variables associated with each E(R₁) and E(R₂) is identified by code letter(s), with F [Fe(II)], B [BH₄⁻], and H pH, in the last column of Table 1.

The statistical analyses of the effects of the variables on the plating mass (R₁) and percentage plating (R₂) are shown by the normal probability plots in parts A and B, respectively, of FIG. 2. In FIG. 2A, only the point corresponding to the pH variable (H) deviates from the straight line defined by the other variables and their various combinations. Consequently, only the pH effect influences the quantity of metal plated, with the modest negative deviation signifying somewhat increased amounts of deposited metal associated with the use of lower pH baths. A plot of the residuals, shown as FIG. 3, forms a straight line through the abscissa zero, verifying that all effects other than pH are associated with random noise and are unimportant in determining the amount of metal plated. In contrast, all the effects in the normal probability plot of FIG. 2B form a straight line with no deviations, indicating that the percentage of metal-plated fibers (R₂) is not affected by any of the variables or combinations thereof over the ranges studied in matrix II. Consequently, our plating process exhibits wide process latitude and is well described by a simple model in which bath pH is the primary factor influencing metal deposition.

FIG. 2 shows normal probability plot analyses. FIG. 2A shows the analysis of the Fe plating mass effects, E(R1). The plot of Pi, calculated from eq 1, vs E(R1)i is shown. The corresponding residuals plot of the [Δ(R1)i, Pi] pairs, calculated from eq 2, is shown as FIG. 3. Numerical values for the [E(R1)i, Pi] and [A(R1)i, Pi] pairs are listed in Tables S1 and S2, respectively. FIG. 2B is the analysis of the percentage of plated fibers effects, E(R₂). The plot of Pi, calculated from eq 1, vs E(R₂)i is shown. Because no variable or combination of variables influenced E(R₂), no residuals plot is shown. Numerical values for the [E(R₂)i, Pi] pairs are listed in Table S3. For all plots, variables or combinations of variables associated with each effect point are identified by the code letters as defined in Table 1.

To better understand and characterize the nature of the plate, the sample from experiment 8 of matrix II was studied in more detail. Neutron activation analysis of the plated fibers confirmed the presence of large amounts of Fe (30.9±1.3 wt %) from the plate and traces of Pd (0.110±0.004 wt %) and Sn (0.191±0.006 wt %) from the catalyzed fiber, as expected. Further analysis indicated that small amounts of boron (1.99±0.10 wt %) were also present in the sample. Normally, the identification of boron in an electroless Fe metal sample would suggest the presence of Fe—B alloy(s). In this case, however, our use of borate buffer represents a possible alternative boron source, since borate is known to bind vicinal diols such as those present in the sugar residues of cellulose fibers. Adsorption of borate to the surface of iron and/or its oxides during iron surface passivation has also been demonstrated, providing yet another potential boron source that must be considered.

XRD and XPS analyses provide additional information concerning boron in our system. The XRD spectrum in FIG. 4 for sample 8 (curve A) exhibits diffraction peaks at 22° (strong, sharp) and 34° (moderate, moderate) clearly identified with the cellulose fiber control (curve B), as well as at 45° (moderate, broad) and ˜65-70° (weak, very broad) from the plate. Although the low intensity and corresponding positional uncertainty preclude definitive identification of the peak at ˜65-70°, the 45° peak is tentatively assigned as Fe (bcc, 110). From the width (i.e., FWHM) of the 45° peak and using Scherrer's equation, we calculate a crystallite particle size of ≦0.7±0.2 nm, consistent with a plate comprising an essentially amorphous Fe phase.

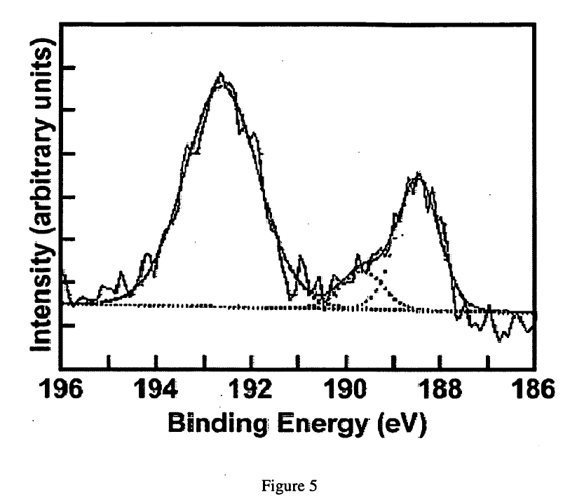

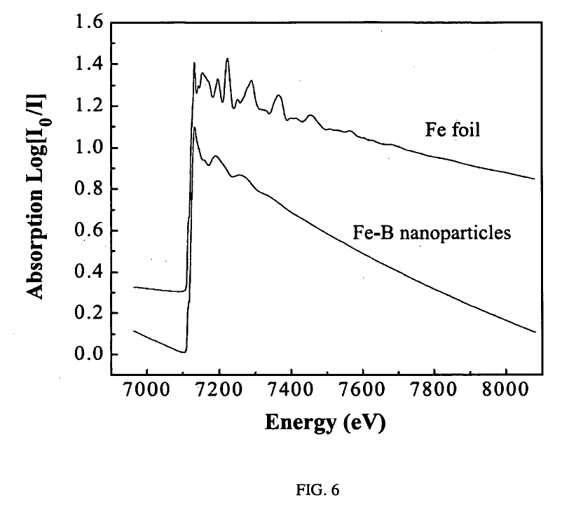

The presence of boron alloyed with this Fe phase is confirmed by the XPS B(1s) spectrum in FIG. 6. A strong peak comprising ˜70% of the total signal area observed at ˜192.7 eV signifies the presence of borate. However, the remaining signal in the energy range ˜187.5 eV-190.5 eV is consistent with the presence of Fe—B alloy(s). Although the asymmetry of this band (additional intensity at higher energy) suggests the presence of at least two alloy components at ˜188.5 eV (major, ˜77%) and ˜189.7 eV (minor, ˜23%), we lack sufficient information to determine the composition and percentage of each alloy at this time. Therefore, we report an average alloy composition of Fe₁₀±₁B estimated from the neutron activation analysis data for Fe and B and the fraction of boron present as alloy from FIG. 5.

Structural and magnetic properties of the FeB microfibers, obtained by electroless deposition on cellulose fibers, were investigated. X-ray diffraction (XRD) showed the presence of an amorphous phase. Extended X-ray absorption fine structure spectroscopy (EXAFS) studies confirmed an amorphous-like structure with the nearest coordination numbers around Fe atom to be 8.7 for Fe and 3.5 for B. The magnetic moment of 2.12 Bohr magnetons/Fe atom is consistent with composition obtained from EXAFS measurements.

The FeB plated microfiber was characterized by optical microscopy, X-ray photoelectron spectroscopy, neutron activation analysis, prompt gamma neutron analysis, and powder X-ray diffraction. The X-ray diffraction analysis of the fibers suggested that the deposited FeB alloy, of composition ˜Fe₁₀B, was amorphous in nature, and the preliminary magnetic measurements indicated them to be magnetic. The important parameters that determine the magnetic properties of Fe in Fe-rich alloys are the interatomic exchange, the moment per Fe ion, and the magnetic anisotropy. In pure Fe with interatomic spacing comparable to or greater than in the bcc phase of Fe metal, Fe has a moment near 2.2 Bohr magnetons/atom and the exchange is positive and moderately large, leading to a ferromagnetic state with magnetic moment above 20 kG and an ordering (Curie) temperature of 670 K. In many alloys, the effect of another metal or metalloid constituent is predominately through dilution, with the moment/Fe atom and the exchange, Fe—Fe pair remaining almost the same. In others, the exchange may be predominantly antiferromagnetic leading to no net Fe moment, even though the individual Fe atoms may have substantial magnetic moments. The addition of B generally leads to an amorphous alloy, which may recrystallize into one or more Fe—B alloys and/or α-phase Fe if exposed to temperatures above 350° C. The amorphous phase is characterized by Fe having essentially the nominal moment for bulk bcc Fe and by magnetically soft properties, e.g., lack of magnetocrystalline anisotropy. However, for nonspherical particles, some magnetic anisotropy arises because of the magnetostatic energy differences for different orientations of the moment. The magnetostatic interaction between particles also may lead to magnetic anisotropy. The combination of the shape induced anisotropy and small particle size can lead to some hysteresis of the magnetization loops, M(H), because of the difficulty of formation of interior domain walls required for incoherent, or wall motion, magnetic reversal. Magnetization measurements in Fe₁₋ₓBₓ glasses indicate that the saturation magnetic moment (μs) depends on the composition and decreases with increasing B content. Amorphous magnetism in the FeB system has also been the subject of theoretical studies. Self-consistent calculations of the electronic structure and magnetic moments in the FeB glass phase confirmed the reduction of magnetic moments with increasing B concentrations.

The EXAFS experiments were performed in transmission geometry at APS bending magnet beamline 20-BM. Incident third harmonic radiation passed by the Si(111) fixed exit monochromator was filtered using a combination of a Rh coated horizontal mirror at 9 mRad for 9.67 keV cutoff and detuning the monochromator second crystal to pass 80% of the incident beam.

Powders were prepared for pelletization by combining ca. 22 mg of FeB-coated fibers, prepared as described previously, with ca. 46 mg of BN and shaking in a mixer/mill for 15 minutes. Pellets were compressed in a 13 mm die at 3 metric tons for 20 seconds. The pellets were mounted inside a closed-cycle He cryostat with Be windows. Transmission maps were made of each of the samples to check for uniformity.

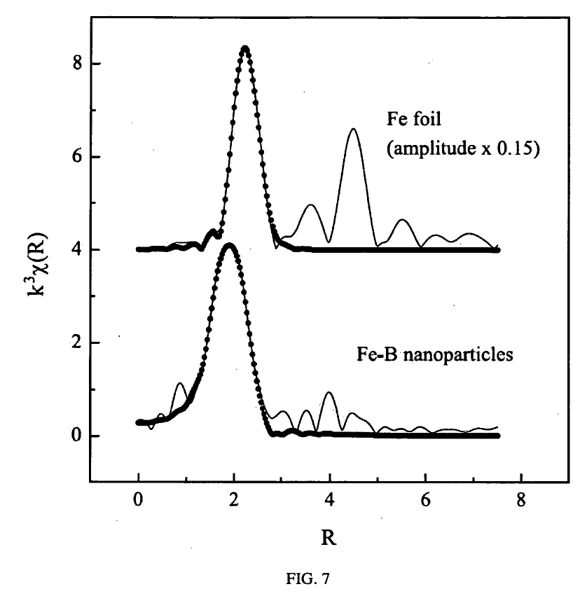

X-ray diffraction profiles taken on a rotating anode source using Cu K_{α} radiation showed only a broad peak at a two-theta value of 45 degrees and a weak broad peak around 65 degrees in addition to peaks from the cellulose. The origin of these two broad peaks is attributed to amorphous FeB coatings on the fibers. Scanning electron microscopy (SEM) was used to characterize the morphology of electroless deposits. The FeB-deposited films are made of nanoparticles that form around Pd/Sn electroless catalyst particles on the surface of the cellulose and grow together to cover the fibers uniformly, conforming to the fibers' surface morphology. The nanoparticles have a diameter of 100-200 nm. The thickness of the coating was about 150 nm. FIG. 6 presents the EXFAS of electroless-deposited iron on cellulose fibers as well as pure Fe foil. Standard procedures were used for background removal and extraction of EXAFS signals in the photon-electron wave-vector space, χ(k), using Autobk. A Fourier transform of k²χ(k) was then carried out to obtain structural information around the absorbing Fe atoms in radial coordinates (see FIG. 7). A significant amplitude reduction was observed in Fourier transform of EXAFS for our Fe nanoparticles compared with the pure Fe foil, suggesting a large disorder exists. Furthermore, the high coordination peaks were damped considerably and distributed very differently from the bcc structure of Fe. These results indicate an amorphous-like structure and are consistent with the X-ray diffraction pattern. Quantitative information of local structural parameters was obtained by nonlinear square fitting of the first peak in real space using the FEFFIT code. The amplitude and phase shift functions were calculated using FEFF8, and the passive electron reduction factors were obtained from pure iron foil.

The initial assumption that only elemental iron exists in the electroless-deposited Fe nanoparticles on cellulose fibers, however very poor fittings were obtained, suggesting other elements should be included. The most probable element existing in the Fe nanoparticles is boron, based on the ˜Fe₁₀B composition previously determined using neutron activation and prompt gamma neutron analyses and the nature of our electroless deposition bath. Such a light element is not easily detected by energy dispersive X-ray analysis (EDX) but it is important for amorphization. Therefore, both single scattering Fe—Fe and Fe—B paths were included in the fitting. As shown in FIG. 7, the simulated EXAFS of the first peak in real space matches well with the experimental one. Table 2 presents the structural parameters of electroless-deposited FeB nanoparticles on cellulose fibers. The nearest coordination numbers around Fe atom are 8.7 for Fe and 3.5 for B, giving the concentration of boron around 29 at. %. In addition, the Fe—Fe path in Fe—B nanoparticles has a short bond distance and a large Debye-Waller factor compared with pure iron, consistent with the presence of a highly distorted amorphous alloy structure.

Table 2:

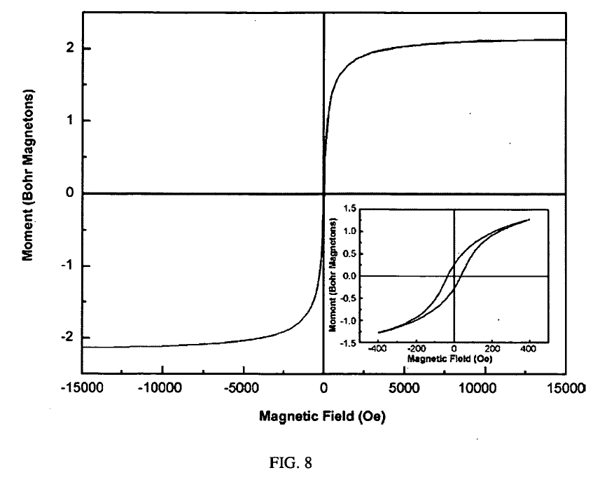

Magnetic moment versus field data was taken using a vibrating sample magnetometer at about 300 K and fields up to 2 T. The data, which are plotted in FIG. 8, show a ferromagnetic response corresponding to a magnetic moment of 2.12 Bohr magnetons/Fe atom in saturating fields. There is some hysteresis at low fields and a small coercive field of about 35 Oe, which is shown in the inset of FIG. 8, and, after an initial steep slope, some rounding of the M(H) curve. The remnant magnetization is about 13% of the saturation value. These properties are consistent with an assembly of magnetically soft amorphous particles of FeB, in agreement with our structural analysis. The magnetic anisotropy observed in our case is significantly less than in the case of Ni-deposited films by electroless deposition, where the coercivity anisotropy is between 200 to 270 Oe, and the saturation varied between 160 to 400 emu/cm, depending on the thickness of the deposited films.

The ability to fabricate FeB amorphous nanoshapes may facilitate useful applications, especially if the tubes can be separated and some degree of self-organization induced. The application of a strong magnetic field, for instance, would induce a high degree of alignment of the particles upon curing in a composite structure containing an initially low viscosity polymer. While the configuration of the particles herein described produces small coercivity, we note that somewhat smaller tube diameters could lead to high coercivity and remanence useful for applications such as atomic force microscopy tips, particulate memory media, or magnetic labeling. On the other hand, somewhat larger diameters and longer particles would allow applications that take advantage of the inherently low anisotropy of amorphous FeB to achieve high permeability, especially at high frequencies where the submicron thickness would allow microwave penetration and hence low dielectric losses. The significant new possibility is that we magnetic particles can be produced of size and shape determined largely by the cellulose substrate. Because of the richness of sizes and shapes available in cellulose fibers, we may, therefore, have the capability to produce magnetic particles with desirable characteristics, including high coercivity and high permeability.

What is claimed as new and desired to be protected by Letters Patent of the United States is:

1. A method of depositing a FeB coating onto a Pd/Sn-catalyzed substrate comprising
providing a Pd/Sn-catalyzed substrate;
adding said substrate to an electroless iron bath, said bath comprising water, a metal ion source, a metal chelator, a pH controller and a reductant; and
allowing said substrate to react to said bath for a period of time sufficient to deposit said FeB coating onto said substrate.

2. The method of claim 1 wherein said Pd/Sn-catalyzed substrate is a Pd/Sn-catalyzed cellulose fiber.

3. The method of claim 1 wherein said metal ion source is iron (II) sulfate heptahydrate.

4. The method of claim 1 wherein said metal chelator is sodium citrate dihydrate.

5. The method of claim 1 wherein said pH controller is a boric acid buffer solution.

6. The method of claim 1 wherein said reductant is sodium borohydride.

7. The method of claim 1 wherein said bath has a pH ranging from about 9.2 to about 10.2.

8. The method of claim 7 wherein said bath has a pH more preferably ranging from about 9.7 to about 10.2.

9. The method of claim 1 wherein said metal ion source has a mole level from about 0.005 M to about 0.050 M.

10. The method of claim 9 wherein said metal ion source has a mole level more preferably ranging from about 0.025 M to about 0.050 M.

11. The method of claim 1 wherein said reductant has a mole ratio relative to the metal ion source mole level, said ratio ranging from about 1 to about 5 times the metal ion source mole level.

12. The method of claim 11 wherein said ratio more preferably ranges from about 1 to about 2 times the metal ion source mole level.

13. The method of claim 1 wherein said metal chelator has a mole ratio relative to the metal ion source mole level, said ratio ranging from about 3 to about 5 times the metal ion source mole level.

14. The method of claim 13 wherein said ratio is more preferably about 5 times the metal ion source mole level.

15. The method of claim 1 wherein said method is carried out at a temperature ranging from about 18 C to about 24 C.

16. The method of claim 1 wherein said period of time ranges from about 4 hours to about 24 hours.

17. The method of claim 16 wherein said period of time more preferably ranges from about 4 to about 5 hours.

18. The method of claim 1 further comprising stirring said bath and said substrate during said time period.
